(19) United States
(12) Patent Application Publication
(10) Pub. No.: US 2013/0196040 A1
(43) Pub. Date: Aug. 1, 2013

(54) METHOD FOR COOKING PRODUCT USING AN ELECTROMAGNETIC OVEN

(71) Applicants: Ramonica GREEN, Fort Worth, TX (US); Ponnattu Kurian JOSEPH, Irving, TX (US); Baninder S. SROAN, Aurora, OH (US)

(72) Inventors: Ramonica GREEN, Fort Worth, TX (US); Ponnattu Kurian JOSEPH, Irving, TX (US); Baninder S. SROAN, Aurora, OH (US)

(73) Assignee: FRITO-LAY NORTH AMERICA, INC., Plano, TX (US)

(21) Appl. No.: 13/362,676

(22) Filed: Jan. 31, 2012

(51) Int. Cl. A21B 1/42; A21D 8/06; A21D 13/00; F26B 3/34

(52) U.S. Cl. 426/243; 34/259; 34/248; 34/255; 426/549

(57) ABSTRACT

A method for cooking a product in an electromagnetic oven. In one embodiment product is conveyed to a convection oven. The product is then cooked to a moisture content of between about 3% and about 20%. The product is then conveyed to an electromagnetic oven where the moisture content is reduced to below 2.5%. The combination of the convection oven and the electromagnetic oven reduces the moisture gradient within the product which results in decreased post packaging stress cracks.

### BACKGROUND OF THE INVENTION

1. Technical Field

The present invention relates to a method for cooking product using an electromagnetic oven.

2. Description of Related Art

Pita bread is a type of flatbread, typically a round pocket bread, believed to have originated in the Middle East. The baking process typically involves forming, by rolling, a flat dough disk that is baked in a hot oven, usually in excess of 500° F., on a flat support surface. The “pocket” inside the finished loaf is created during cooking when the outside layers of the bread are seared, thus forming a cap that impedes the release of steam from the interior of the bread. This trapped steam puffs up the dough in the middle of the bread forming a pocket. As the bread cools and flattens, a pocket is left in the middle that can be later stuffed for making sandwiches and the like. Pita “chips” or “crisps” (these two terms are used interchangeably herein) can be made by cutting or chopping pita bread loaves into chip sized pieces.

Often, after packaging the pita chips develop undesirable stress cracks. These cracks are not visible immediately after manufacture but become visible subsequent to packaging. Consequently, it is desirable to have a method to reduce the undesirable stress cracks.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is side profile view of two ovens in series in one embodiment.

### DETAILED DESCRIPTION

Several embodiments of Applicants' invention will now be described with reference to the drawings. Unless otherwise noted, like elements will be identified by identical numbers throughout all FIGURES. The invention illustratively disclosed herein suitably may be practiced in the absence of any element which is not specifically disclosed herein.

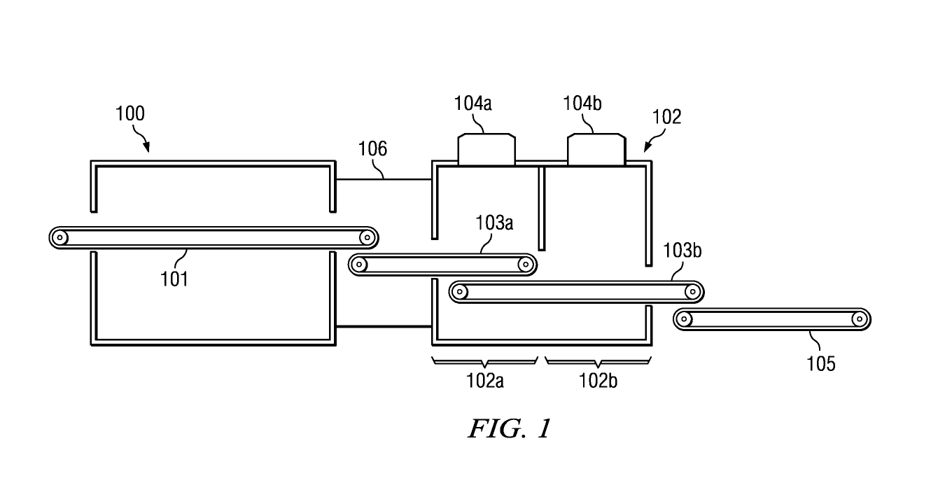

FIG. 1 is a side profile view of two ovens in series in one embodiment. In one embodiment the series of ovens are used to cook pita bread. A convection oven 100 is upstream from an electromagnetic oven 102. As used herein, “downstream” and “upstream” refer to relative points or locations in the process or apparatus. Thus, an event taking place downstream occurs later in the process and follows events which took place upstream. Product is conveyed from the convection oven conveyor 101 to the radio frequency oven conveyor 103a.

The convection oven 100 can take many forms. In one embodiment the oven 100 is a convection oven; however, the oven can comprise any oven known in the art. The oven 100 can be an impingement oven in which air is directed at the product at a high rate of speed. Additionally, the convection oven 100 can be a thru-flow oven in which air is directed to the product. The convection oven 100 can comprise virtually any convection or other ovens known in the art. As depicted the convection oven 100 is connected to the electromagnetic oven 102 via enclosing walls 106. Enclosing walls 106 prevent the hot air of the convection oven 100 from leaving the system. Thus, the enclosing walls 106 prevent the wasting of energy. Likewise, the enclosing walls 106 prevent cool air from entering either oven which also saves energy.

The electromagnetic oven 102 comprises an electromagnetic source 104. The electromagnetic 102 can comprise a range of electromagnetic ovens including radio frequency ovens. In one embodiment the radio frequency oven comprises a microwave oven. As depicted the electromagnetic oven 102 is partitioned into two ovens: an upstream electromagnetic oven 102a and a downstream electromagnetic oven 102b. As depicted, each partition comprises its own electromagnetic source 104a, b. In other embodiments two or more partitions may share an electromagnetic source. While two partitions have been illustrated the invention is not so limiting as virtually any number from one to more than one can be used. Multiple ovens can offer the ability to better control the cooking by, for example, having different temperatures in each partition.

In one embodiment, the electromagnetic oven 102 comprises at least one cascading conveyor 103a, 103b. The cascading conveyors 103a, 103b operate to flip or turn the product. Turning the product allows for more uniform heating. Consequently, because the product is turned, a bed of product can be used more effectively as opposed to a monolayer of product. This is an advantage over the prior art which required a monolayer of product to ensure uniform heat application. In one embodiment, operation of the cascading conveyor 103a, 103b mimics the tumbling action found in conventional clothes dryers. Such operation promotes uniform heating and dehydration. Further, such operation prevents product burning or other over-cooking particularly in electromagnetic baking or dehydration applications where runaway heating or uneven heating can be prevalent. In one embodiment the cascading conveyor 103a, 103b is a conveyor which drops product to a lower elevation. As can be seen from FIG. 1, the first conveyor 103a has a higher elevation than the second conveyor 103b. In operation product is flipped as it is dropped to a lower elevation. While shown as having only a single drop within the electromagnetic oven 102, the invention is not so limited as multiple drops can be utilized. Likewise, while the drop is illustrated as being located at the partition, the drops can be located anywhere within and outside of the electromagnetic oven 102.

As discussed, because a thicker bed of product can be utilized, more product can be placed on the conveyor 103a, 103b resulting in increased throughput. In one embodiment the bed of product ranges from about ½ inch to about 4 inches.

As noted, in one embodiment the ovens are used to cook pita chips made from pita bread dough. While an embodiment utilizing pita bread will be discussed, the methods and apparatuses discussed are not so limited as other products may also be cooked.

Pita chips can be formed by any method known in the art. One such method is disclosed in U.S. patent application Ser. No. 13/016,585, the entirety of which is hereby incorporated by reference. Often these chips are partially cooked, cooled, sheeted, and thereafter finish cooked to a desired moisture content. As used herein, dough refers to a product which has not been finished cooked. In one embodiment a dough refers to a product whose moisture content had not been reduced to below 3% by weight. Accordingly, in one embodiment the term dough includes bread, including pita bread. In one embodiment pita bread dough is converted to a pocket pita after sheeting into smaller dough discs. The pita is partially baked into pita bread. The loaves are then cut and conveyed into the convection oven 100.

Table 1 below shows the dough formula used to produce a pita chip in accordance with one embodiment.

TABLE 1

| Ingredient | Weight Percentage |
|---|---|
| Wheat Flour | 30-62 |
| Whole Wheat Flour | 0-31 |
| White Whole Wheat Flour | 1-2 |
| Sugar | 1-2 |
| Salt | 0-2 |
| Oat Fiber | 0-1 |
| Yeast | 1 |
| Water | 20-30 |

In one embodiment product is conveyed into the convection oven 100. As noted product can comprise dough, bread, and virtually any product which is desired to cook. For example the product can comprise pita dough, pita bread, wheat based dough or bread, flour based dough or bread, and other snacks. The product conveyed into the convection oven 100 can comprise virtually any moisture content. In one embodiment the product enters the convection oven 100 at greater than about 20% moisture by weight. In other embodiments, as illustrated in Table 1, the moisture content of the product entering the convection oven 100 is between about 20 and 30% by weight, whereas in other embodiments it ranges from 20 to 35%. The convection oven 100 lowers the moisture content of the product. In one embodiment, the moisture content is reduced to between about 3% and about 20%, whereas in other embodiments the moisture content is reduced to between about 7% and about 15%.

The time and temperature of the oven can be adjusted depending on the amount of product to be cooked, the beginning moisture content of the product, the bed thickness, etc. In one embodiment the air within the oven does not exceed 150° F. In one embodiment the product has a residence time within the oven of between 3 and 9 minutes. The convection oven 100 can be either continuous or batch in operation.

Convection cooking affects the flavor and texture of the final product. The final product flavor is primarily a function of the time and temperature of the convection cooking Accordingly, pita chips, for example, which are not cooked in a convection oven 100 will have dissimilar attributes compared to pita chips cooked in a convection oven 100.

In one embodiment, after the product has achieved a moisture content of between about 3% and about 20%, or about 7% to about 15% in other embodiments, the product is conveyed into an electromagnetic oven 102. The moisture content is then reduced to below about 3% by weight. In another embodiment the moisture content is reduced to below about 2% by weight, and in yet another embodiment the moisture content is reduced below 1.5%. The time and power settings necessary to reach the specified moisture content are dependent upon a variety of factors, including but not limited to, the amount of product, the bed thickness, and whether the bed is turned. As mentioned above, in one embodiment a cascading conveyor 103a, 103b turns the bed to promote uniform cooking As noted, the cascading conveyor results in thicker bed depth and better uniformity which allows for increased throughput. As with the convection oven, the radio frequency cooking can be either batch or continuous.

Product, such as dough, with moisture contents as high as between about 3% and about 20%, or about 7% and about 15% are not typically conveyed into a radio frequency oven 102. It is noted that those skilled in the art would often refer to dough at this moisture content as par-baked. However, it has been surprisingly found that many unexpected benefits result from introducing product with moisture content as high as between about 3% to 20% or between 5% and about 15% into the radio frequency oven 102. First, less stress cracks are produced compared to the prior art. Previously, the final moisture content was achieved through convection cooking Convection cooking dehydrates the product from the outside of the product to the inside of the product. As such, while a desired moisture content is achieved, a moisture gradient exists within the individual chip as a higher moisture concentration is found at the center of the chip compared to the outer surface of the chip. This is believed to be due in part to the fact that the convection cooking dehydrates the outside of the product first which leaves the center portion of the product having a comparatively larger moisture content. This often results in subsequent stress cracks which occur after the product has been packaged. Thus, the product will appear without cracks but hours or days later the product begins to undesirably crack due to the moisture gradient. However, when product with a higher moisture content, for example between about 5% and about 15%, is received by the radio frequency oven 102 from a convection oven 101, these cracks are minimized or reduced.

The electromagnetic oven 102 typically dehydrates from the inside of the product to the outside of the product. The inside-out dehydration of the radio frequency oven 102 supplements the outside-in cooking of the convection oven 101 and minimizes or eliminates the final moisture gradient. Because of the increased moisture content of the product fed into the electromagnetic oven 102, there is still sufficient moisture available for removal to reach a desired moisture content of 1-2.5%. As an example, assuming the product entering the electromagnetic oven 102 comprises a moisture content of 10% and the final desired moisture content is 2%, this provides a difference of 8% which can be removed via the electromagnetic oven 102. This allows sufficient moisture to be removed from the inside of the product. Consequently, the final product has a decreased moisture gradient compared to the prior art. This results in fewer stress cracks compared to prior art product. As such, a more pleasing product results. In one embodiment there is about a 5% to about 9% difference in the moisture content of the product entering the electromagnetic oven 102 to the product exiting the electromagnetic oven 102. The same results are not achieved if there is not sufficient moisture available for removal by the electromagnetic oven 102. If, for example, product entering the electromagnetic oven 102 comprises a moisture content of 2.5% and the final desired moisture content is 1.5%, this provides a difference of 1.0%. This slight decrease in moisture content by the electromagnetic oven 102 is not sufficient to equalize the moisture gradient of the product. As such, stress cracks still result.

Second, increased throughput is an unexpected result. As product is removed from the convection oven 100 at a higher moisture content, the residence time within the convection oven 100 can be decreased. Alternatively, more product can be placed in the convection oven 100. Either way, throughput through the oven is increased.

Third, the combination of convection cooking and electromagnetic cooking allows the benefits of the convection cooking, such as texture and flavor, to be retained. As noted, if dough was not partially cooked in a convection oven 100 but instead was cooked entirely in an electromagnetic oven 102, the flavor and texture of the final product would suffer as the flavor benefits which are attributable to convection cooking would be lacking However, the combination of the convection oven 100 and the electromagnetic oven 102 allow the desirable product attributes which are attributable to the convection oven 100 to be maintained. Further, it is believed that the combination of convection cooking as well as electromagnetic cooking minimizes the moisture gradient within the product, which in turn minimizes or eliminates stress cracks. As stated, the outside-in cooking of the convection oven is complemented by the inside-out cooking of the electromagnetic oven so as to minimize any resulting moisture gradient. In one embodiment the described method reduces stress cracks by about 40% compared to embodiments wherein the method is not utilized. Likewise, in one embodiment breakage reduction, or the amount of product which breaks, decreases by about 39% compared to embodiments wherein the method is not utilized.

Now referring back to FIG. 1, another embodiment will be discussed. For illustrative purposes, assume the temperature of the air within the electromagnetic oven 102 is 150° F. To dehydrate the product the product must be heated to a temperature at least 212° F. to vaporize the moisture, assuming atmospheric pressure. This means that the product is actually being cooled by the air. Again, the product is heated to 212° F. but the surrounding air is 150° F. Thus, the air is constantly cooling the product. Even if the product is introduced into the electromagnetic oven at a temperature of 212° F. or higher, if the air within the electromagnetic oven is less than the temperature of the product, then the air is cooling the product. Any heat lost by the product, in the form of sensible heat, is heat that must be replaced by the oven. In one embodiment, to decrease the amount of heat lost by the product to the air the air is pre-heated to increase its temperature. This can be accomplished with any heat exchanger or device known in the art which will maintain the air at a specified temperature. For example, make-up air can be introduced into the electromagnetic oven 102 via a pre-heater. The air can be heated and maintained at any temperature, but in one embodiment the air is maintained at a temperature of about 212° F. This will reduce or eliminate the cooling effect of the air. Even if the temperature of the air is not maintained at 212° F., any additional heating will reduce the cooling effect of the air. In one embodiment the air is maintained above 150° F., whereas in other embodiments the air is maintained between about 175 and 212° F. In still other embodiments, the air is maintained at a temperature greater than 212° F.

While the invention has been particularly shown and described with reference to a preferred embodiment, it will be understood by those skilled in the art that various changes in form and detail may be made therein without departing from the spirit and scope of the invention.

### ADDITIONAL DESCRIPTION

The following clauses are offered as further description of the disclosed invention.
1. A method for cooking a product, said method comprising the steps of:
   a. conveying a product to a convection oven;
   b. cooking said product in said convection oven to a moisture content between about 3% and about 20%;
   c. conveying said product to an electromagnetic oven;
   d. cooking said product in said electromagnetic oven to a moisture content below 3%.
2. The method according to any preceding clause wherein said convection oven comprises a thru-flow oven.
3. The method according to any preceding clause wherein said electromagnetic oven comprises a radio frequency oven.
4. The method according to any preceding clause wherein said radio frequency radio comprises a microwave oven.
5. The method according to any preceding clause wherein said conveying of step c) comprises a continuous conveyor.
6. The method according to any preceding clause wherein said conveying of step c) comprises conveying on at least one cascading conveyor.
7. The method according to any preceding clause wherein said conveying of step a) comprises conveying pita dough.
8. The method according to any preceding clause wherein said conveying of step a) comprises conveying dough.
9. The method according to any preceding clause wherein said conveying of step a) comprises conveying pita bread.
10. The method according to clause 9 wherein said pita bread comprises an initial moisture content of greater than 25%.
11. The method according to clause 9 wherein said pita bread dough comprises about 30 to about 62 percent wheat flour, about 0 to about 31 percent whole wheat flour, and 1 to about 2 percent white whole wheat flour, about 1 to about 2 percent sugar, about 0 to about 2 percent salt, about 0 to about 1 percent oat fiber, about 1 percent yeast, and about 30 to about 34 percent moisture.
12. The method according to any preceding clause wherein said cooking of step d) comprises cooking to a moisture content of less than 1.5%.
13. The method according to any preceding clause wherein said cooking of step b) comprises cooking said product in said convection oven to a moisture content between about 7% and about 15%.
14. The method according to any preceding clause wherein said cooking of step d) further comprises maintaining air within said electromagnetic to a temperature greater than 150° F.
15. The method according to any preceding clause wherein said cooking of step d) further comprises maintaining air within said electromagnetic to a temperature between 175° F. and 212° F.
16. The product made from the method of clause 1.

What is claimed is:

1. A method for cooking a product, said method comprising the steps of:
a. conveying a product to a convection oven;
b. cooking said product in said convection oven to a moisture content between about 3% and about 20%;
c. conveying said product to an electromagnetic oven;
d. cooking said product in said electromagnetic oven to a moisture content below 3%.

2. The method of claim 1 wherein said convection oven comprises a thru-flow oven.

3. The method of claim 1 wherein said electromagnetic oven comprises a radio frequency oven.

4. The method of claim 1 wherein said radio frequency radio comprises a microwave oven.

5. The method of claim 1 wherein said conveying of step c) comprises a continuous conveyor.

6. The method of claim 1 wherein said conveying of step c) comprises conveying on at least one cascading conveyor.

7. The method of claim 1 wherein said conveying of step a) comprises conveying pita dough.

8. The method of claim 1 wherein said conveying of step a) comprises conveying dough.

9. The method of claim 1 wherein said conveying of step a) comprises conveying pita bread.

10. The method of claim 9 wherein said pita bread comprises an initial moisture content of greater than 25%.

11. The method of claim 9 wherein said pita bread dough comprises about 30 to about 62 percent wheat flour, about 0 to about 31 percent whole wheat flour, and 1 to about 2 percent white whole wheat flour, about 1 to about 2 percent sugar, about 0 to about 2 percent salt, about 0 to about 1 percent oat fiber, about 1 percent yeast, and about 30 to about 34 percent moisture.

12. The method of claim 1 wherein said cooking of step d) comprises cooking to a moisture content of less than 1.5%.

13. The method of claim 1 wherein said cooking of step b) comprises cooking said product in said convection oven to a moisture content between about 7% and about 15%.

14. The method of claim 1 wherein said cooking of step d) further comprises maintaining air within said electromagnetic to a temperature greater than 150° F.

15. The method of claim 1 wherein said cooking of step d) further comprises maintaining air within said electromagnetic to a temperature between 175° F. and 212° F.

16. The product made from the method of claim 1.
